(19) United States
(12) Patent Application Publication
(10) Pub. No.: US 2025/0094561 A1
(43) Pub. Date: Mar. 20, 2025

(54) VERIFIABLE SECURE DATASET OPERATIONS WITH PRIVATE JOIN KEYS

(71) Applicant: GOOGLE LLC, Mountain View, CA (US)

(72) Inventors: Carlos Cela, Mountain View, CA (US); John Tobler, Mountain View, CA (US); Eugene Shaphir, Mountain View, CA (US); Chanda Patel, Mountain View, CA (US); Quaseer Mujawar, Mountain View, CA (US); Farshid Shariatzadeh, Mountain View, CA (US); Dina Kurman, Mountain View, CA (US); Minh Hoang, Mountain View, CA (US)

(21) Appl. No.: 18/573,374

(22) PCT Filed: Jul. 24, 2023
(86) PCT No.: PCT/US2023/028515

§ 371 Date: Dec. 21, 2023

Related U.S. Application Data
(60) Provisional application No. 63/391,794, filed on Jul. 24, 2022.

(51) Int. Cl. G06F 21/53

(52) U.S. Cl. CPC G06F 21/53; G06F 2221/033

(57) ABSTRACT

To performing a join operation, a module executing in a trusted execution environment (TEE) receives a first dataset including personal identifiable information (PII) data and non-PII data from a first-party (1P) data source. The module pre-processes the PII data to generate first formatted PII data, the first formatted PII data conforming to a predefined format: matches, in the TEE, the first formatted PII data to second formatted PII data included in a second dataset: performs a join operation between the first dataset and the second dataset based on the matching, to generate a joined dataset: and provides, to a data service operating independently of the 1P data source, the joined dataset.

### CROSS-REFERENCE TO RELATED APPLICATIONS

This application claims priority to and the benefit of the filing date of provisional U.S. patent application Ser. No. 63/391,794 entitled “VERIFIABLE SECURE DATASET JOINING WITH PRIVATE JOIN KEYS,” filed on Jul. 24, 2022. The entire contents of the provisional application are hereby expressly incorporated herein by reference.

### FIELD OF THE DISCLOSURE

This disclosure relates to a secure computing environment and, more particularly, to techniques for improving data security and computational efficiency when performing such operations as joining datasets from multiple parties, implemented in a cloud or another suitable environment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, certain services or applications may attempt to join datasets from different, independent parties. The datasets often include data that one party does not wish to, and/or is not allowed to, share with another party, which for simplicity can be referred to as “restricted data.” An example of such restricted data is personal identifiable information (PII). It may not be possible to simply remove this data prior to performing joining operations because this data can operate as the joining key, i.e., the data that logically links records in separate datasets.

For instance, a certain data service DS₁ can store readings from temperature sensors of set S₁ of devices identified by device identifiers ID_{d1}, ID_{d2}, . . . . ID_{N} at different times, and a second data service DS₂ can maintain readings from pressure sensors of set S₂ that at least partially overlaps set S₁. It may be desirable to join the temperature and pressure readings for an intersection of sets S₁ and S₂ without revealing identities of devices corresponding to particular sensor readings.

It is desirable to provide a computing environment in which join operations on datasets from multiple sources can execute securely and efficiently.

### SUMMARY

The techniques of this disclosure support join operations on datasets that eliminate the need for the source of first-party data (1PD) to reveal sensitive data such as PII to another party, without requiring that the 1PD source (or “customer data source”) perform computationally expensive hashing and/or encryption locally, or hand off the data to another party for these operations.

Using the techniques of this disclosure, a system can guarantee that it is sufficient for a customer data source to connect to only a secure connector operating in a trusted execution environment (TEE) in order to provide the data, and that the secure connector does not provide access to the customer data to any other party. These techniques further allow the customer data source to not share credentials with modules other than the secure connector.

The secure connector can receive the 1PD and encrypt the 1PD at least partially, e.g., the PII fields. The encrypted data then flows safely through the extract-transform-load (ETL) pipeline toward a PII match module, also implemented in the TEE. Only attested secure code can gain access to the cryptographic key(s) required to decrypt the encrypted fields, and no party can extract sensitive information from the encrypted PII, nor can any party modify the secure connector or PII match module functionality.

### BRIEF DESCRIPTION OF THE DRAWINGS

FIG. 1 is a block diagram of an example computing environment in which at least some of the techniques of this disclosure can be implemented;

FIG. 2A is a block diagram illustrating an example computing architecture including a secure control plane and a data plane, which can be utilized in the computing environment of FIG. 1A;

FIG. 2B is a block diagram illustrating another example of computing architecture similar to FIG. 2A, except that here the environment includes additional infrastructure for managing cryptographic keys and privacy budget;

FIG. 3A is a block diagram of an example pipeline for performing a secure join operation on a 1PD with another dataset, which can be implemented in the computing environment of FIG. 1A or another suitable environment;

FIG. 3B is a block diagram of a pipeline generally similar to that of FIG. 3A, but with the secure connector and the PII match module combined into a single entity;

FIG. 4A is a flow diagram of an example method in a secure connector for ingesting cleartext 1PD, pre-processing the 1PD, and re-encrypting the 1PD, which can be implemented in the environment of FIG. 3A or 3B;

FIG. 4B is a flow diagram of an example method generally similar to that of FIG. 4A, but with at least a portion of the 1PD arriving at the secure connector in an encrypted format;

FIG. 4C is a flow diagram of an example method generally similar to that of FIG. 4A, but with the secure connector hashing the PII in the 1PD prior to sending the 1PD to the PII match module;

FIG. 5A is a flow diagram of an example method in a PII match module for receiving, from a secure connector, 1PD with pre-processed and encrypted PII, decrypting the PII, and matching the PID with another dataset using the PII fields, which can be implemented in the environment depicted in FIG. 3A or 3B;

FIG. 5B is a flow diagram of an example method generally similar to that of FIG. 5A, but with the PII match module performing the matching used hashed PII fields or values;

which can be implemented in the environment depicted in FIG. 3B;

FIG. 5C is a flow diagram of an example method in a PII match module for generating a joined dataset for a data service, which can be implemented in the environment of FIG. 3A or 3B;

FIG. 6A is a flow diagram of an example method in a customer data source for providing 1PD to the secure connector in cleartext;

FIG. 6B is a flow diagram of an example method in a customer data source for encrypting PII fields in a 1PD and providing the 1PD to the secure connector;

FIG. 7A is a block diagram illustrating the transformation of PII and non-PII data in 1PD as the 1PD travels through the environment of FIG. 3A or 3B, in accordance with the methods of FIGS. 4A, 5A, and 6A;

FIG. 7B is a block diagram illustrating the transformation of PII and non-PII data in 1PD as the 1PD travels through the environment of FIG. 3A or 3B, in accordance with the methods of FIGS. 4A, 5A, and 6B; and

FIG. 7C is a block diagram illustrating the transformation of PII and non-PII data in 1PD as the 1PD travels through the environment of FIG. 3A or 3B, in accordance with the methods of FIG. 4B, 5B, and 6A.

### DETAILED DESCRIPTION OF THE DRAWINGS

As discussed in more detail below, a secure connector and a PII match module can execute in a TEE to securely and efficiently perform join operations on datasets from different parties. The secure connector in some implementations also performs pre-processing of the PII, so that the PII from different datasets is in the same format, to allow for efficient matching operations. The secure connector, the PII match module, and components of an ETL pipeline can be implemented in a cloud computing environment, or simply “cloud.”

These components allow the burden of data obfuscation, which can include hashing and/or encryption, to shift from a customer data source to the cloud, while securing the PII from inspection by other parties. Implementing these modules in a TEE allows the PII match module to perform matching and/or joining in cleartext but with guarantees of end-to-end privacy of the PII and integrity of data processing.

These techniques address such technical problems associated with prior approaches as the inability of 1P data owners to retain control over their datasets and prevent other parties of accessing individual-level PII, or the need of 1P data owners to share PII with various intermediate parties (e.g., services that apply analytics to 1PD). Even when a data owner hashes PII fields to obfuscate certain information, and then a certain platform uses the hashed field as the joining keys to correlate or join datasets, these approaches are computationally burdensome because data often must conform to a particular format for correct ingestion. As there are frequently many sources of 1PD, hashing and comparisons in multiple different formats results in inefficiencies and even errors.

As a more specific example, a phone number can be in such formats as ‘555.555.5555’, ‘555-555-5555’, or ‘(555) 555-5555,’ with each of these strings corresponding to different hashes. Mailing addresses result in even more variety of formats. Moreover, although hashing provides obfuscation, hashed data has security vulnerabilities such as exposure to dictionary attacks, for example.

These techniques are applicable in a wide variety of applications, including for example the ad tech industry in which advertisers measure effectiveness of advertising campaigns by determining which consumer segments or audiences buy certain types of products or determining which advertisements cause the highest volumes of sales. To this end, systems can combine 1PD (e.g., sales data in a customer relationship management (CRM) system) and advertising campaign data (e.g., information about people who interacted with an ad). Because both the 1PD and the campaign data contain PII such as phone numbers, 1P addresses, email addresses, physical addresses, etc., the PII can operate as the joining key(s).

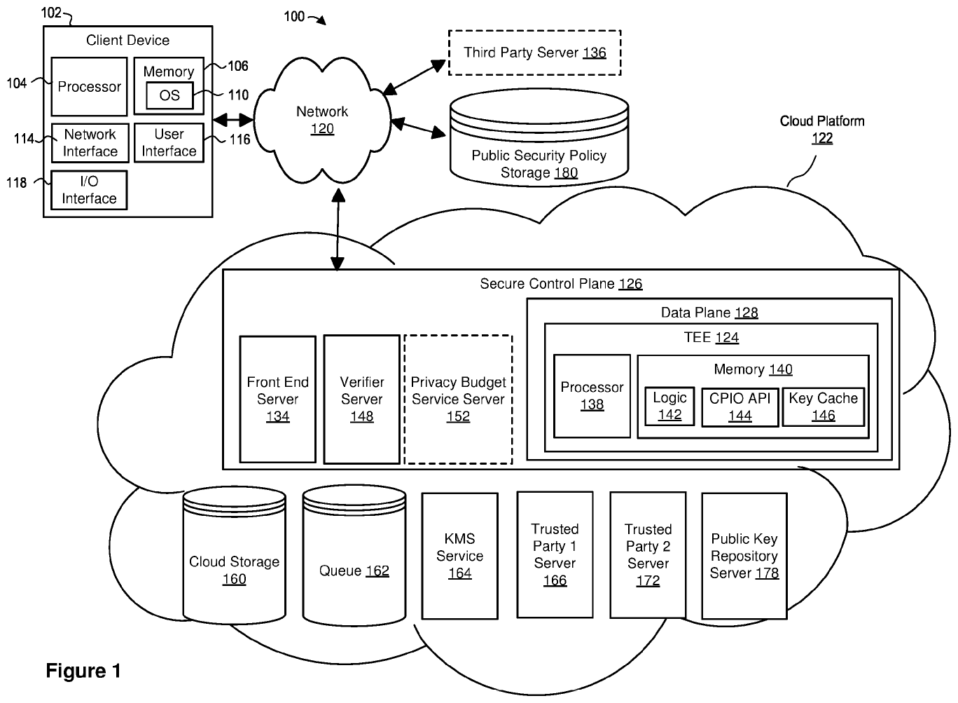

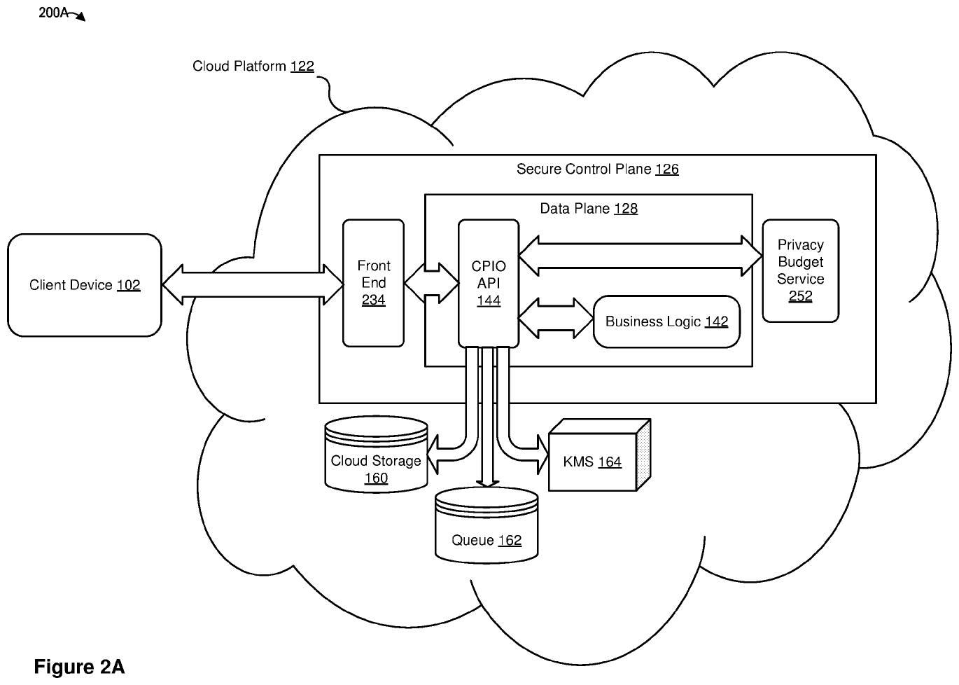

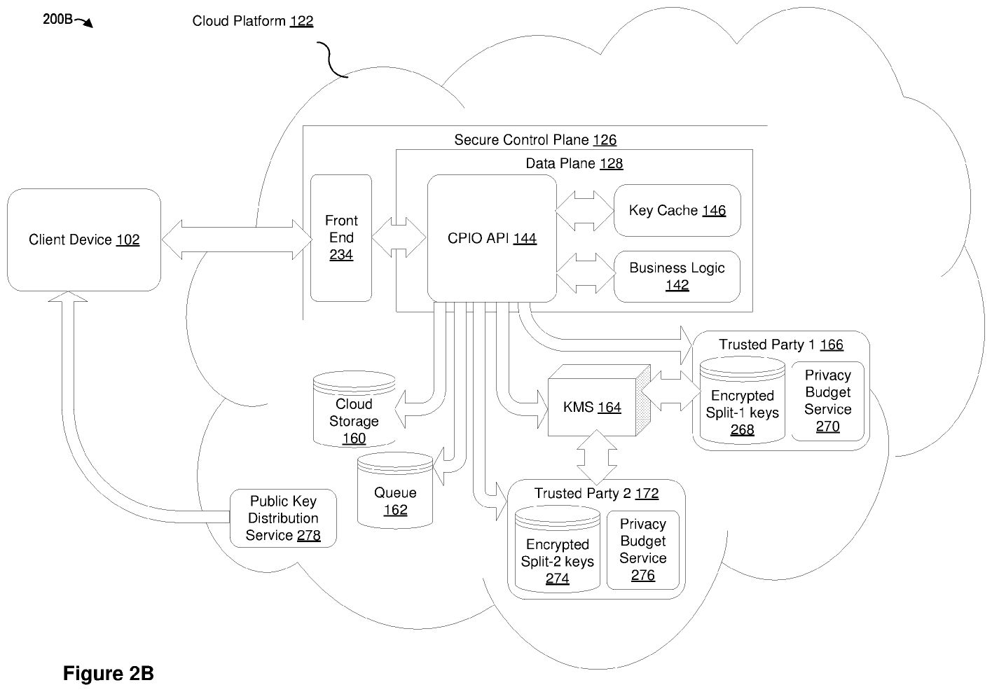

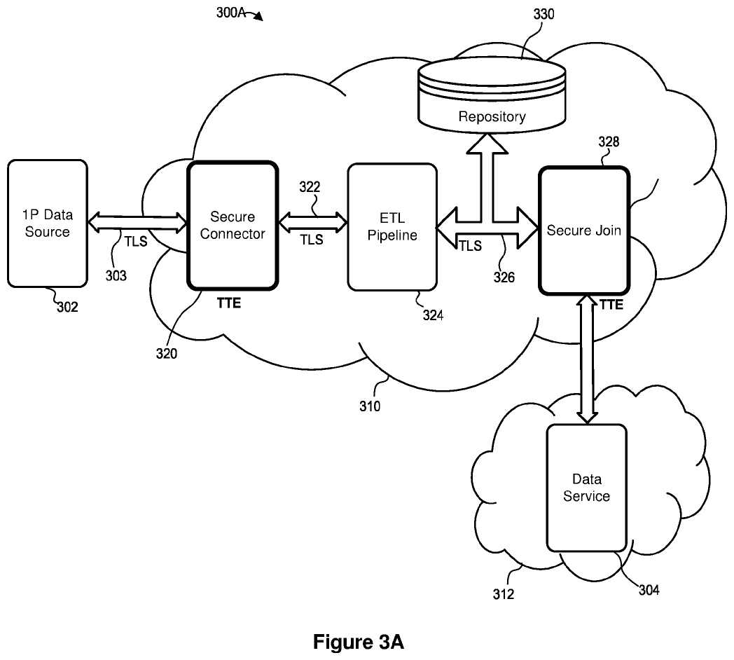

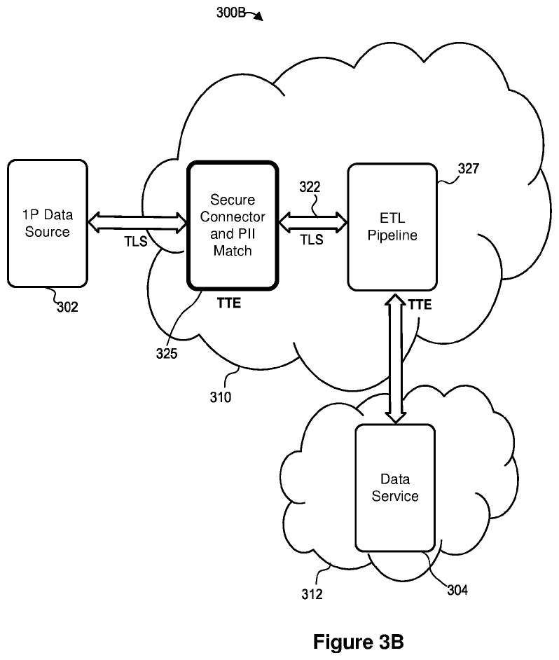

An example environment suitable for implementation of such techniques is discussed first with reference to FIGS. 1, 2A, and 2B. Example pipelines for the matching/joining operations are then considered with reference to FIGS. 3A and 3B, followed by a discussion of example methods in a secure connector, a PII match module, and a 1P data source.

### Computing Environment for Secure Multi-Party Computation and Join Operations

A secure control plane (sometimes referred to herein as “SCP”), described herein provides a non-observable secure execution environment where a service can be deployed. In particular, arbitrary business logic (e.g., code for an application) providing the service can be executed within the secure execution environment in order to provide the security and privacy guarantees needed by the workflow, with no computation at runtime observable by any party. The state of the environment is opaque even to the administrator of the service, and the service can be deployed on any supported cloud.

As one example, two clients producing data, client 1 and client 2, may wish to combine the data streams they receive from their respective customers, such that the clients can generate quantitative metrics related to these customers, where the quantitative metrics cannot be derived from their individual datasets. As a more particular example, client 1 can be a retailer that has data indicative of customer transactions, and client 2 can be an analytics engine capable of measuring the effectiveness of advertisement campaigns for products offered by the retailer, for example.

Client 2 may provide a service with algorithms that client 2 claims will perform data analysis securely. However, client 1 may not wish to expose its customer data to client 2 in a manner that would potentially allow the data to be exfiltrated or used in a manner that does not adhere to privacy and security guarantees of client 1. Client 1 therefore would like to ensure that (1) its customer data cannot be exfiltrated by client 2 or any other party, and (2) the logic being used to analyze the customer data adheres to the security requirements of client 2. The techniques disclosed herein provide a secure execution environment in which the business logic executes, such that sensitive data analyzed by the business logic remains encrypted everywhere except within the secure execution environment, and provide attestation such that any party can ensure that the logic running within the secure execution environment performs as guaranteed.

Generally speaking, the service performing the computation (i.e., processing an event or request using business logic) is split between a data plane (DP) and a secure control plane (SCP). The business logic specific for the computation is hosted within the DP, where the DP is within a TEE, also referred to herein as an enclave. The business logic may be provided to the DP as a container, where a container is a software package containing all of the necessary elements to run the business logic in any environment. The container may, for example, be provided to the SCP by the business logic owner. Functionally, the SCP provides a secure execution environment and facilities to deploy and operate the DP at scale, including managing cryptographic keys, buffering requests, keeping track of the privacy budget, accessing storage, orchestrating a policy-based horizontal autoscaling, and more. The SCP execution environment isolates the DP from the specifics of the cloud environment, allowing for the service to be deployed on any supported cloud vendor without changes on the DP. Both DP and SCP work together by communicating through an Input/Output (I/O) Application Programming Interface (API), also referred to herein as a Control Plane I/O API, or CPIO API.

In an example implementation, all data traversing the SCP is always encrypted, and only the DP has access to the decryption keys. For example, for a particular service, the business logic may include performing event aggregation and outputting an aggregate summary report. In such an example, the SCP delivers encrypted requests from one or more event sources to the DP, which in time decrypts the requests, processes the requests, checks the privacy budget, and generates and sends out the encrypted report. Further, the decryption keys, when outside the DP, may be bit-split, such that only the DP can assemble the decryption keys within the TEE. Depending on the desired application, the output from the DP can be redacted or aggregated in such a way that the output can be shared and no individual user's data can be identified or exfiltrated.

The SCP provides several privacy, trust, and security guarantees. With regard to privacy, services using the SCP can provide guarantees that no stakeholder (e.g., a device operated by a client, the cloud platform, a third party) can act alone to access or exfiltrate cleartext (i.e., non-encrypted), sensitive information, including the administrator of the SCP deployment. Further, with regard to trust, the DP is running in a secure execution environment with a trusted state at the time the enclave is started. For example, the SCP may be implemented on a Trusted Platform Module (TPM) or Virtual Trusted Platform Module (vTPM), in accordance with Secure Boot standards, and/or using a trusted and/or certified operating system (OS). Starting from an audited codebase and a reproducible build, cryptographic attestation is used to prove the DP binary identity and provenance at runtime (as will be discussed in more detail below). Further, a key management service (KMS) releases cryptographic keys only to verified enclaves. As a result, any tampering of the DP image results in a system that is unable to decrypt any data. The cloud provider is implicitly trusted given the strong incentives the cloud provider has to guarantee its Terms of Service (ToS) guarantees. With regard to security, the secure execution environment is non-observable. The memory of the secure execution environment is encrypted or otherwise hardware-protected from access from other processes. Core dumps are not possible in an example implementation. All data is encrypted in transit and at rest, and all I/O from/to the DP is encrypted. No human has access to the private keys in cleartext (e.g., KMS is locked-down, keys are split, and keys are only available within the DP, which is within the secure execution environment.

The SCP distributes trust in a way that three stakeholders need to cooperate in order to exfiltrate cleartext user event data. The SCP also uses the distributed trust model to guarantee that two stakeholders need to cooperate to tamper with the privacy budget service. Distributed trust works using both event decryption and a privacy budget service. Regarding event decryption, the private key needed to decrypt events received at the SCP is generated in a secure environment and bit-split between at least two KMSs, each under the control of an independent Trusted Party. The KMSs are configured to only release key material to a DP that matches a specific hash. If the DP is tampered with, they keys will not be released. In such a scenario, the service can be launched but will not be able to decrypt any event. Similarly, the privacy budget service may be distributed between two independent Trusted Parties and may use transactional semantics to guarantee that both Trusted Parties' budgets match, which allows for the detection of budget tampering.

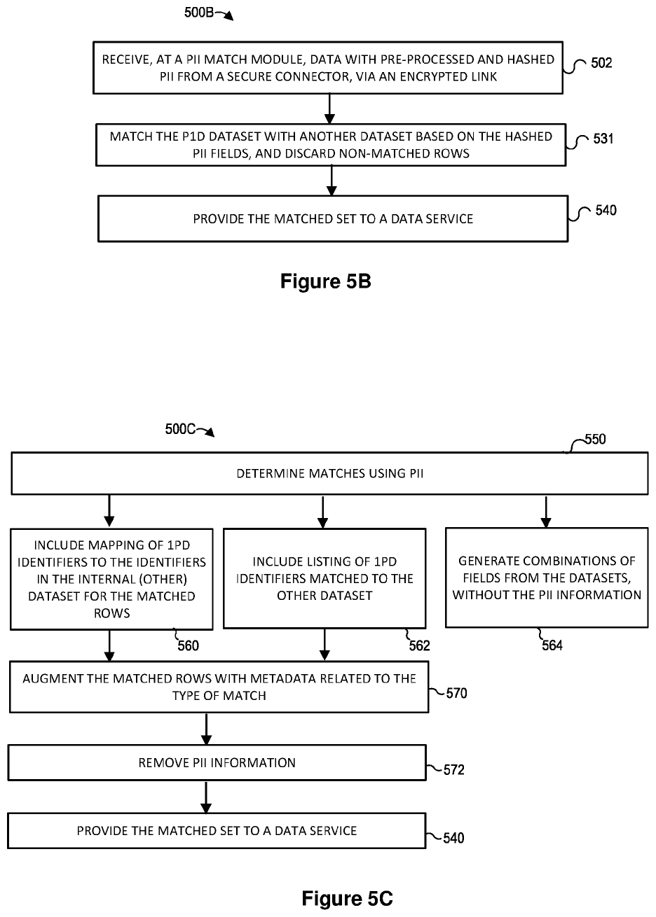

The SCP, as will be discussed with reference to FIG. 2B, also provides mechanisms for attesting that any business logic running on the DP corresponds to the publicly released code, allowing other parties to verify the business logic being used to analyze sensitive data. The full codebase for the business logic (with the exception of scenarios described with reference to FIG. 5 involving proprietary business logic) is available to all stakeholders to examine and audit. Builds are reproducible, and any stakeholder can build the DP container. Building the deployable images generates a set of cryptographic hashes (e.g., Platform Configuration Registers (PCRs)). All parties can therefore verify that the deployed products match the published codebase by comparing the PCRs. The DP, after building the logic, provides PCRs (e.g., via a CPIO API) to parties requesting to verify the built logic. KMSs, for example, are configured to only release key material to images matching the PCRs generated from building the published logic. This guarantees that the private keys to decrypt sensitive information are only available to the images that correspond to a specific commit of a specific repository.

Turning to an example computing system that can implement the SCP of this disclosure, FIG. 1 illustrates an example computing system 100. The computing system 100 includes a client computing device 102 (also referred to herein as the client device 102), coupled to a cloud platform 122 (also referred to herein as the cloud 122) via a network 120. The network 120 in general can include one or more wired and/or wireless communication links and may include, for example, a wide area network (WAN) such as the Internet, a local area network (LAN), a cellular telephone network, or another suitable type of network or combination of networks. While the examples of this disclosure primarily refer to a cloud-implemented architecture, it should be understood that the techniques disclosed herein, including techniques for providing a secure execution environment in which to process sensitive data, for generating, splitting, and distributing keys, and for providing a mechanism by which to verify proprietary business logic, can be applied in non-cloud systems as well.

The client device 102 may be a portable device such as a smartphone or a tablet computer, for example. The client device 102 may also be a laptop computer, a desktop computer, a personal digital assistant (PDA), a wearable device such as a smart glasses, or other suitable computing device. The client device 102 may include a memory 106, one or more processors (CPUs) 104, a network interface 114, a user interface 116, and an input/output (I/O) interface 118. The client device 102 may also include components not shown in FIG. 1, such as a graphics processing unit (GPU). The client device 102 may be associated with a service user, who is an end user of the service provided by the SCP, discussed below. The end user operates the client device 102 (or, more specifically, the browser or application on the client device 102) that transmits requests/events to the service. To send a request or event to the service, the client device 102 encrypts the request/event using a public key, which the client device 102 can retrieve from a public key repository (e.g., a public key repository server 178). The client device 102 is exemplary only. As discussed below, the cloud platform 122 may receive incoming events and/or requests from the client device 102, from a browser/application/client process executing on the client device 102, or from another computing device issuing requests on behalf of the client device 102 or forwarding requests from the client device 102. Further, while only one client device is illustrated in FIG. 1, the computing system 100 may include multiple client devices capable of communicating with the cloud platform 122.

The network interface 114 may include one or more communication interfaces such as hardware, software, and/or firmware for enabling communications via a cellular network, a WiFi network, or any other suitable network such as the network 120. The user interface 116 may be configured to provide information, such as responses to requests/events received from the cloud platform 122 to the user. The I/O interface 118 may include various I/O components (e.g., ports, capacitive or resistive touch sensitive input panels, keys, buttons, lights, LEDs). For example, the I/O interface 118 may be a touch screen.

The memory 106 may be a non-transitory memory and may include one or several suitable memory modules, such as random access memory (RAM), read-only memory (ROM), flash memory, other types of persistent memory, etc. The memory 106 may store machine-readable instructions executable on the one or more processors 104 and/or special processing units of the client device 102. The memory 106 also stores an operating system (OS) 110, which can be any suitable mobile or general-purpose OS. In addition, the memory 106 can store one or more applications that communicate data with the cloud platform 122 via the network 120. Communicating data can include transmitting data, receiving data, or both. For example, the memory 106 may store instructions for implementing a browser, online service, or application that requests data from/transmits data to an application (i.e., business logic) implemented on the DP of a secure execution environment on the cloud platform 122, discussed below.

The cloud platform 122 may include a plurality of servers associated with a cloud provider to provide cloud services via the network 120. The cloud provider is an owner of the cloud platform 122 where an SCP 126 is deployed. While only one cloud platform is illustrated in FIG. 1, the SCP 126 may be deployed on multiple cloud platforms, even if those cloud platforms are operated by different cloud providers. The servers providing the cloud platform 122 may be distributed across a plurality of sites for improved reliability and reduced latency. Individual servers or groups of servers within the cloud platform 122 may communicate with the client device 102 and with each other via the network 120. Example servers that may be included in the cloud platform 122 are discussed in further detail below. While not illustrated for each server in FIG. 1, each server included in the cloud platform 122 may include one or more processors, similar to the processor(s) 104, adapted and configured to execute various software stored in one or more memories, similar to the memory 106. The servers may further include databases, which may be local databases stored in memory of a particular server or network databases stored in network-connected memory (e.g., in a storage area network). The servers also may include network interfaces and I/O interfaces, similar to the interfaces 114 and 118, respectively. Further, it should be understood that while certain components are described as an individual server, generally speaking, the term “server” may refer to one or more servers. Moreover, while functions are generally described as being performed by separate servers, some functions described herein may performed by the same server.

The cloud platform 122 includes the SCP 126, which includes a TEE 124. The TEE 124 is a secure execution environment where the DP 128 is isolated. A TEE, such as the TEE 124, is an environment that provides execution isolation and offers a higher level of security than a regular system. The TEE 124 may utilize hardware to enforce the isolation (referred to as confidential computing). The cloud provider is considered the root of trust of the SCP 126, abiding by the Terms of Service (ToS) agreement of the cloud platform 122. The hardware manufacturer of the servers providing the TEE 124 also have ToS guarantees, and therefore also provide additional layers of trust. The SCP 126 also utilizes techniques to guarantee that the state at boot time is safe, including using a minimalistic OS image recommended by the cloud provider, and using a TPM/vTPM-based secure boot sequence into that OS image.

One or more servers of the cloud platform 122 perform control plane (CP) functions (i.e., to support the SCP 126), and one or more servers perform data plane (DP) functions. All functions of the DP 128 are carried out by servers within the TEE 124. The TEE 124 may be deployed and operated by an administrator. The administrator can audit the logic to be implemented on the DP 128 and verify against a hash of the binary image to deploy the logic 142. On the CP, there may a front end server 134 that receives external requests/event indications (e.g., from the client device 102), buffers requests/events until they can be processed by the DP 128, and forwards received requests to the DP 128. Generally speaking, as used herein, a request may also refer to an event, or may include one or more events, unless otherwise noted. In some implementations, there is a third party server 136 between the client device 102 and the SCP 126. The third party server 136 (which may include one or more servers, and might or might not be hosted on the cloud platform 122) may be responsible for receiving requests (which are encrypted by the client device 102) from the client device 102 and later dispatching the encrypted requests to the SCP 126. In some cases, the third party is the administrator of the service. The third party server 136 does not have keys with which to decrypt the requests. The third party server 136 may, for example, aggregate requests into batches and store the batches (e.g., on cloud storage 160). The third party server 136 or cloud storage server 160 may notify the front end server 134 that requests are ready to be processed, and/or the front end server 134 may subscribe to notifications that are pushed to the front end server 134 when batches are added to the cloud storage 160.

The DP 128 includes a server (which may include one or more servers), which includes one or more processors 138 (similar to the processor(s) 104), and one or more memories 140 (similar to the memory 106). The memory 140 includes business logic 142 (also referred to as the logic 142), which may be executed by the processor 138. The business logic 142 is for implementing whichever application or service is being deployed on the TEE 124. The memory 140 also may store a key cache 146, which stores cryptographic keys for encrypting and decrypting communications. Further, the memory 140 includes a CPIO API 144, which includes a library of functions for communicating with other elements of the cloud platform 122, including components on the CP of the SCP 126. The CPIO API 144 can be configured to interface with any cloud platform provided by cloud provider. For example, in a first deployment, the SCP 126 may be deployed to a first cloud platform provided by a first cloud provider. The DP 128 hosts the particular business logic 142, and the CPIO API 144 facilitates communications between the logic 142 and the first cloud platform. In a second deployment, the SCP 126 may be deployed to a second cloud platform provided by a second cloud provider. The DP 128 can host the same business logic 142 as the first deployment, and the CPIO API 144 is configured to facilitate communications between the logic 142 and the second cloud platform. Thus, the SCP 126 can be deployed to different cloud platforms without editing the underlying business logic 142, and only configuring the CPIO API 144 to interface with the particular cloud platform.

There may be additional CP-level services provided by servers of the cloud platform 122 that support the SCP 126. For example, a verifier server 148 may implement a verifier module capable of verifying whether the business logic 142 conforms to a security policy, as will be discussed below with reference to FIG. 5. As another example, a privacy budget service server 152 may implement a privacy budget service that verifies whether the privacy budget for a user or device has been exhausted. One or more privacy budget services, additionally or alternatively, may be implemented by Trusted Parties, as discussed with reference to FIG. 2B.

Additionally, the cloud platform 122 may include other servers and databases in communication with the SCP 126, as described in the following paragraphs. These servers may facilitate the CP functions of the SCP 126. In particular, CP functions may be distributed across several servers, as will be discussed below. The DP 128, however, remains within the TEE 124 and is not distributed outside of the TEE 124.

Cloud storage 160 may store encrypted batches of requests, as mentioned above, before the encrypted batches are received by the front end server 134. The cloud storage 160 may also be used to store responses, after the DP 128 has processed a received request, or to perform storage functions of other components of the cloud platform 122. Queue 162 may be used by the front end server 134 to store pending requests before they can be analyzed by the DP 128. For example, after receiving a request from the client device 102, the front end server 134 can receive the request and temporarily store the pending request in the queue 162 until the DP 128 is ready to process the request. As another example, after receiving a notification that a batch of requests from the third party server 136 is stored within the cloud storage 160, the front end 134 can retrieve the batch and place the batch in the queue 162 where the batch awaits analysis by the DP 128.

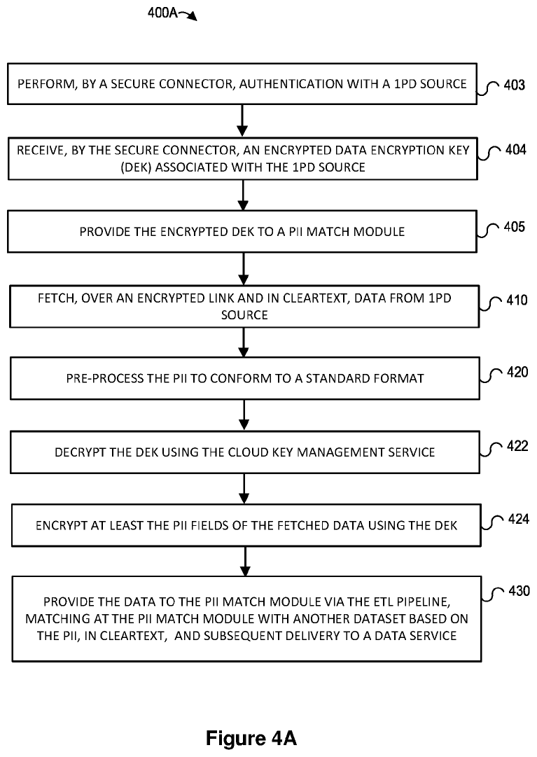

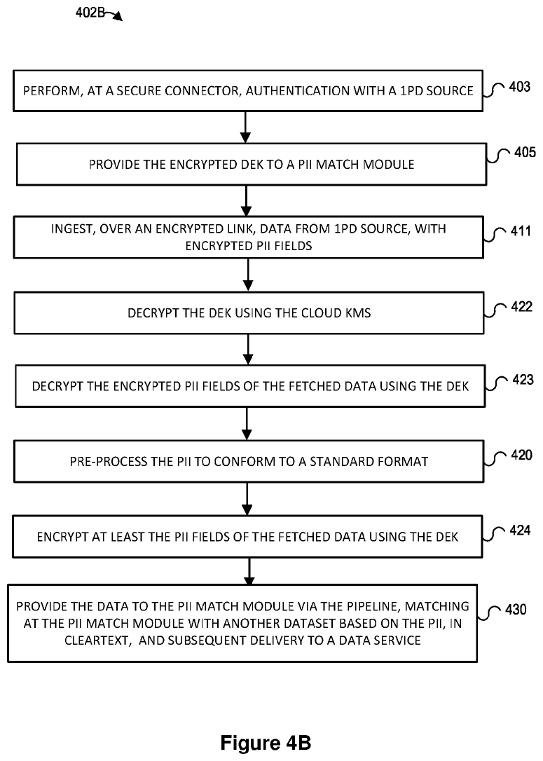

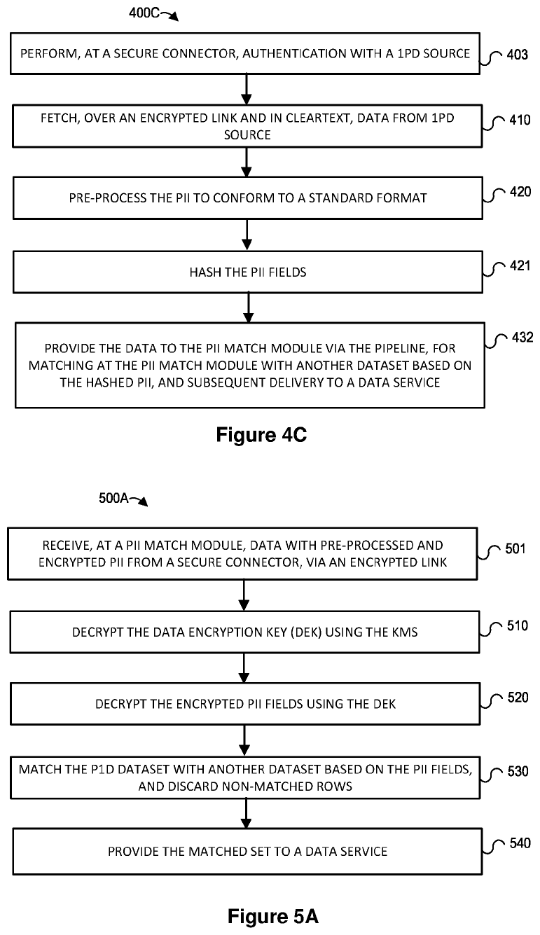

The key management server (KMS) 164 provides a KMS, which generates, deletes, distributes, replaces, rotates, and otherwise manages cryptographic keys. The Trusted Party 1 server 166 and the Trusted Party 2 server 172 are servers associated with a Trusted Party 1 and a Trusted Party 2, respectively, that provide the functionality of each Trusted Party. While FIG. 1 illustrates only two Trusted Parties, the cloud platform 122 may include multiple Trusted Parties. Each Trusted Party may manage the privacy budget, and can also audit the logic 142 implemented on the DP 128 to verify the build product against the hash of the published logic. Trusted Parties own the creation and management of the asymmetric keys used for encryption and decryption of user data. The Trusted Parties may securely generate keys and publish public keys to the world. Private keys, as will be discussed in detail with reference to FIG. 4, can be bit-split into two parts (one split under the control of each Trusted Party, although any number of N-splits can also be supported, e.g., in the case where there are N Trusted Parties). An envelope-encryption technique may be used in which each Trusted Party encrypts its split for each key with a KMS's symmetric key and saves the encrypted split in their repository. Envelope encryption allows for rotation of the envelope without necessarily rotating the key within the envelope. Public keys may be stored and managed by a public key repository server 178. Additionally or alternatively, the KMS server 164 may manage public keys.

The computing system 100 may also include public security policy storage 180. which may be located on or off the cloud platform 122. The public security policy storage 180 stores security policies such that the security policies are accessible by the public (e.g., by the client device 102, by components of the cloud platform 122). A security policy (also referred to herein as a policy) describes what actions or fields are allowed in order to compose the output of a service. A policy can also be described as a machine-readable and machine-enforceable Privacy Design Document (PDD). Policies will further be described with reference to FIG. 5.

Referring next to FIG. 2A, an example architecture 200A illustrates connections between components and software elements of the computing system 100. The client device 102 can retrieve public keys (e.g., from the public key repository server 178) in order to address requests to the service being implemented on the DP 128 (i.e., by the business logic 142). For example, the client device 102 may initiate a request to access content provided by the service, or may issue an event including user behavior data.

Encrypted requests from the client device 102 are received first by a front end module 234 (i.e., a module implemented by the front end server 134) of the SCP 126. In some implementations, the requests are first received by a third party that batches the requests before notifying the front end 234 (or causing the front end 234 to be notified). In such cases, the front end 234 may retrieve the encrypted requests from the cloud storage 160. In any event, the front end 234 passes encrypted requests to the DP 128 using functions defined by the CPIO API 144 The front end 234 may store encrypted requests in the queue 162 until the DP 128 is ready to process the requests and retrieves the requests from the queue 162. The DP 128 decrypts the requests and processes the requests in accordance with the business logic 142. Decrypting the requests may include communicating with a KMS 264 (i.e., a cloud KMS implemented by the KMS server 164) to retrieve and assemble private keys for decrypting the requests, and/or with Trusted Parties, as in FIG. 2B.

Processing the requests may include communicating with a privacy budget service 252 (e.g., implemented by the privacy budget service server 152), using the CPIO API 144 functions, to check the privacy budget and ensure compliance with the privacy budget. The privacy budget keeps track of requests and events that have been processed. There may be a maximum number of requests originating from a specific user, for example, that can be processed during a particular computation or period. Ensuring compliance with a privacy budget prevents parties analyzing the output from the DP 128 from extracting information regarding a specific user. By checking compliance with the privacy budget, the DP 128 provides a differentially private output.

The results from processing the requests can be encrypted by the DP 128, and can be redacted and/or aggregated such that the output does not reveal information concerning specific users. The DP 128 can store the results in, for example, the cloud storage 160, where the results can be retrieved by parties having the decryption key for the results. As one example, if processing results for the third party server 136, the DP 128 can encrypt the results using a key that the third party server 136 can decrypt.

Turning to FIG. 2B, an architecture 200B is similar to the architecture 200A, except that additional details are illustrated regarding key management and privacy budget. In comparison to FIG. 2A, FIG. 2B also illustrates the Trusted Party 1 server 166 (referred to herein as Trusted Party 1 166 for brevity), the Trusted Party 2 server 172 (referred to herein as Trusted Party 2 172 for brevity), and the public key distribution service 278. The public key distribution service 278 provides public keys to the client device 102, which the client device 102 can use to address requests to the DP 128, front end 234, or third party server 136 that aggregates requests (not shown in FIG. 2B). The public key distribution service 278 may be operated by the public key repository server 178, or by the KMS server 164. The Trusted Party 1 166 includes a key cache 268 containing encrypted split-1 keys (i.e., an encrypted first portion of a private key), whereas the Trusted Party 2 172 includes a key cache 274 containing encrypted split-2 keys (i.e., an encrypted second portion of the private key). Each of the Trusted Parties 166, 172 may also provide a privacy budget service 270, 276, and may each manage an instance of the privacy budget. Distributing management of the privacy budget to two Trusted Parties helps to ensure that no one Trusted Party can tamper with the privacy budget. Both privacy budget services 270, 276 should enforce the same privacy budget; thus, if the two services return different outputs, the SCP 126 can recognize that one of the Trusted Parties 166, 172 has tampered with the privacy budget. The architecture illustrated in FIG. 2B prevents any one Trusted Party from having total control over private decryption keys or the privacy budget. A single Trusted Party cannot act alone to provide unlimited budget to any user, and therefore a single Trusted Party cannot aggregate the same batch of data repeatedly.

### Example Pipelines for Performing Secure Match/Join Operations

Next, FIG. 3A illustrates a pipeline 300A which can be at least partially implemented in the environments discussed above. The pipeline 300A receives a dataset from a 1P data source 302, and provides the results of matching/joining to a data service 304. The parties controlling systems 302 and 304 are separate and independent, and it is desirable for the data service 304 to perform operations (e.g., analytics) using the dataset from the 1P data source 302 without relying on, or having any access to, the data included in the dataset, especially the PII. The 1P data source 302 can be any suitable external source of 1PD keyed by cleartext PII or any other suitable data. The 1P data source 302 can be for example a CRM, a proprietary system, a file available over the Internet, etc.

The 1P data source 302 provides a dataset to a secure connector 320 implemented in a cloud 310, over an encrypted link 303. The link 303 can be for example an SSL/TLS connection established over the internet. The secure connector 320 can operate in an audited and attested TEE. As discussed in more detail below, the secure connector 320 in operation can hash and/or encrypt some or all of the received dataset. The secure connector 320 provides hashed/encrypted dataset to an ETL pipeline 324 via an encrypted link 322. The ETL pipeline 324 can move the dataset either to a data repository 330 or to a secure join module 328, over an encrypted link 326. The ETL pipeline 324 in general can perform data transformations and field mapping to conform a certain schema, and format non-encrypted fields. The repository 330 can be a data storage service that allows time-deferred consumption of data ingested from the 1P data source 302.

The PII match module 328 can operate in an audited and attested TEE, similar to the secure connector 320. The PII match module 328 in operation can match and join a 1P dataset with another dataset, which can come from another 1P data source or can be internal to the data service 304 for example. The PII match module 328 then provides a privacy-safe output to the data service 304, which can operate on a cloud platform 312 or any other suitable platform.

As illustrated in FIG. 3A, the ETL pipeline 324 can deliver data to either the secure join module 328, to be consumed immediately by the data service 304, or to the repository 330. The 330 repository supports the “ingest once and use many” workflows. The repository 330 always stores the sensitive PII as either hashed or encrypted. In some implementations, additional layers such as encryption-at-rest further guarantee the security of the data stored in the repository 330.

Referring to FIG. 3B, a pipeline 300B is similar to the pipeline 300A, but here a single component 325, operating in a TEE, implements the functionality of both the secure connector 320 and the PII match module 328. However, this simplified architecture does not support storing encrypted PII in the repository 330 for later consumption.

Referring generally to FIGS. 3A and 3B, the one or more TEEs supporting the secure connector and the PII match module are services that have provable characteristics of security and privacy. More particularly, these services ensure that parties can verify that they are connected to the correct server; that parties can verify what a TEE box does by inspecting a code repository; and that parties can verify that the repository code corresponds exactly to the image running in the server. Further, attestation infrastructure in the cloud provider 310 guarantees that the required decryption keys can only be utilized within TEEs having a specific signature.

### Example Workflows for Performing Secure Match/Join Operations

Next, several example workflows which the pipelines of FIGS. 3A and 3B can support are discussed with reference to FIGS. 4A-7C. The methods of FIGS. 4A-6B can be implemented using suitable processing hardware, e.g., as sets of software instructions stored on a non-transitory computer readable medium and executable by one or more processors.

Referring first to FIG. 4A, a method 400A can be implemented in the secure connector 320 or 325. The method 400A includes cleartext PII matching, server-side encryption, and usage of customer-generated keys. The method 400A begins at block 403, where the secure connector performs authentication with a 1PD source. More particularly, the secure connector can initiate a connection between a 1P data source (e.g., the 1P data source 302) and the secure connector. A customer first can provide encrypted credentials to guarantee that the secure connector is the only entity that can connect to the 1P data source. The KMS 164 (see FIGS. 1, 2A, and 2B) can use a decryption key for the credentials under a customer-owned account, and the KMS 164 ensures that only the secure connector 320 can perform a decryption operation using these credentials.

The secure connector can decrypt the credentials and use the decrypted credentials to authenticate to the 1P data source. Data transfer occurs over SSL/TLS or a similar protocol that allows for authentication of the endpoint(s). The secure connector and the 1P data source in some cases can use mutual authentication (mTLS) to give assurances to both ends of the connection that data is flowing from and to the intended endpoints. Certain 1P data sources require repeated use of credentials, while other 1P data sources rely on a token, a certificate, or another technique to fetch data over a secure connection. According to another implementation, the secure connector and the 1P data source use a certificate and an encryption schema to provide access to the data instead of credentials. The certificate required to connect is encrypted and used in a way that only the secure connector has the certificate available to establish a successful connection.

In any case, the customer associated with the 1P data source locally generates a data encryption Key DEK and a key encryption key (KEK) using the cloud KMS discussed above. The computing system of the customer can encrypt the DEK with the KEK using the API of the cloud KMS. The customer also configures the KMS so as to allow the secure connector and the PII match module to decrypt the KEKs. At block 404, the secure connector receives the encrypted DEK associated with the 1P data source. At block 405, the secure connector provides the encrypted DEK to the PII match module.

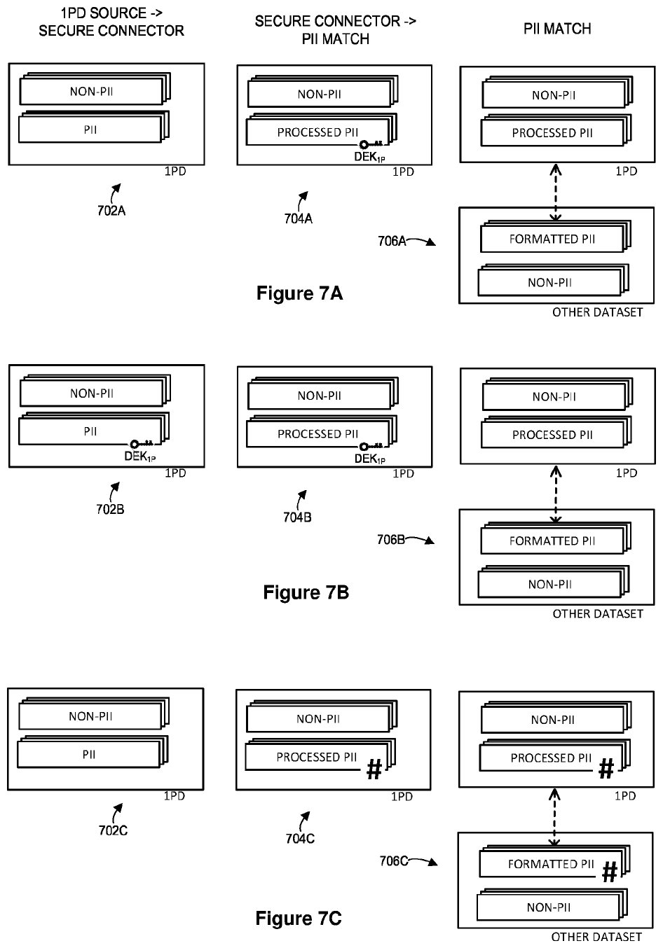

At block 410, the secure connector ingests the dataset from the IP data source, in cleartext. As illustrated for further clarity in FIG. 7A, according to this workflow, the dataset at stage 702A includes both non-PII and PII fields in cleartext. At block 420, the secure connector pre-processes the PII to match a certain standard format. This transformation is likely to increase the matching rate at the PII match module, and thus reduce the error rate as well as improve efficiency.

At block 422, the secure connector decrypts the DEK using the KMS, and encrypts the at least the PII fields of the ingested dataset with the DEK (see FIG. 7A, stage 704A). At block 430, the secure connector sends the data to the PII match module via the pipeline, for matching with another dataset based on the PII. As discussed with reference to FIG. 5A, the PII match module can perform the matching and joining in cleartext. FIG. 7A illustrates this cleartext comparison at stage 706A.

Next, FIG. 4B illustrates a method 400B. Like blocks are labeled with like reference numbers, and only the differences between the methods 400A and 400B are considered next. The method 400B includes cleartext PII matching and client-side encryption. At block 411, the secure connector ingests (e.g., fetches) a dataset from a 1P data source, and in this case the dataset includes encrypted PII, as also illustrated in FIG. 7B, stage 702A.

FIG. 4C illustrates a method 400C, which includes using hashed PII matching. Like blocks are labeled with like reference numbers, and only the differences between the methods 400A and 400Bare considered next. The method 400B includes cleartext PII matching and client-side encryption. At block 421, the secure connector hashed the PII fields and, at block 432, the secure connector provides the dataset with hashed PII fields to the PII match module for hash-based comparison. FIG. 7C illustrates that, at stage 702C, the dataset includes cleartext PII and non-PII data; at stage 704C, the PII is pre-processed and hashed; and at stage 70BC, the comparison is based on formatted/processed and hashed PIIs.

FIG. 5A is a flow diagram of an example method 500A in a PII match module such as the PII match module 325. The method 500A can correspond to the method 400A or 400B in the secure connector.

At block 501, the PII match module receives a dataset with pre-processed and encrypted PII from the secure connector, via an encrypted link (see FIG. 7A, stage 704A). At block 510, the PII match module decrypts the data using the DEK using the KMS, and then, at block 520, uses the DEK to decrypt the encrypted PII fields.

At block 530, the PII match module matches the 1PD dataset with another dataset, such as an internal dataset, based on the PII fields (see FIG. 7A, stage 706A). The PII match module also can discard all non-matched rows. At block 540, the PII match module can provide the matched dataset to a data service, such as the data service 304.

FIG. 5B is a flow diagram of another example method 500B in a PII match module such as the PII match module 328 or 325. The method 500B can correspond to the method 400C in the secure connector. At block 502, the PII match module receives a dataset with pre-processed and hashed PII from the secure connector. At block 531, the PII match module can match the dataset with another dataset based on the hashed PII fields, and discard the non-matched rows. At block 540, the PII match module can provide the matched dataset to a data service, such as the data service 304.

FIG. 5C is a flow diagram of an example method 500C in a PII match module for generating a joined dataset for a data service. At block 550, the PII match module can determine the matches between the datasets using PIIs, in a non-hashed or hashed format, per methods 500A and 500B, respectively.

At block 560, the PII match module can map external to internal identifiers for the matched rows of the datasets. At block 570, the PII match module also can augment each row of the output dataset with metadata indicating the type of a match that occurred (e.g. based on email, phone, address) for post-processing (e.g. conflicts and duplicates resolution). At block 572, the PII match module can remove all PII from the output dataset.

Additionally or alternatively to block 560, the PII match module at block 562 can generate a list of internal identifiers matched between the datasets. The flow also can proceed to block 570, where the PII match module augments each row with metadata as discussed above. Still further, additionally or alternatively to blocks 560 and 562, the PII match module at block 564 can include any combination of fields from both datasets and/or metadata, but without any of the PII fields.

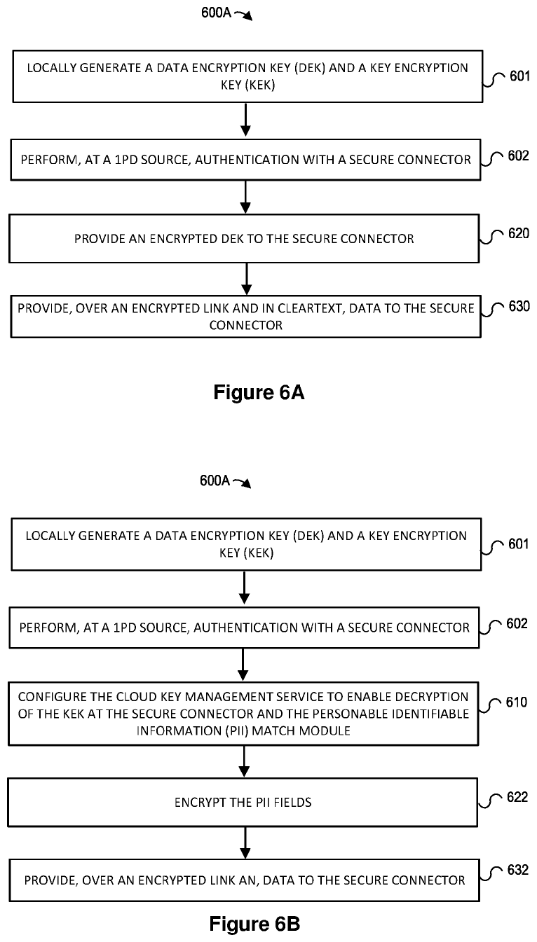

FIG. 6A is a flow diagram of an example method 600A, which can be implemented in a customer data source (e.g., the 1P data source 302), for providing 1PD to the secure connector in cleartext. At block 601, the customer data source locally generates a DEK and a KEK using the cloud KMS. The customer data source encrypts the DEK with the KEK using the API of the cloud KMSI. At block 602, the customer data source performs authentication with the secure connector. A secure credentials service then can configure the cloud KMS to enable decryption of the KEK at the secure connector and the PII match module. At block 620, the customer data source provides an encrypted DEK to the secure connector and, at block 630, provides data to the secure connector in cleartext over a secured link (see FIG. 7A, stage 702A or Fig. C, stage 702C).

FIG. 6B is a flow diagram of an example method 600B generally similar to that of FIG. 6A. However, here the customer data source encrypts the PII fields at block 622 (see FIG. 7B, stage 702B) and provides the dataset to the secure connector over an encrypted link.

### Additional Considerations

The following additional considerations apply to the foregoing discussion.

A client device in which the techniques of this disclosure can be implemented (e.g., the client device 102) can be any suitable device capable of wireless communications such as a smartphone, a tablet computer, a laptop computer, a desktop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the client device in some cases may be embedded in an electronic system such as the head unit of a vehicle or an advanced driver assistance system (ADAS). Still further, the client device can operate as an internet-of-things (IoT) device or a mobile-internet device (MID). Depending on the type, the client device can include one or more general-purpose processors, a computer-readable memory, a user interface, one or more network interfaces, one or more sensors, etc.

Certain embodiments are described in this disclosure as including logic or a number of components or modules. Modules can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in one or more servers for performing a join operation, the method comprising:
receiving, at a module executing in a trusted execution environment (TEE) from a first-party (1P) data source, a first dataset including personal identifiable information (PII) data and non-PII data;
pre-processing the PII data to generate first formatted PII data, the first formatted PII data conforming to a predefined format;
matching, in the TEE, the first formatted PII data to second formatted PII data included in a second dataset;
performing a join operation between the first dataset and the second dataset based on the matching, to generate a joined dataset; and
providing, to a data service operating independently of the 1P data source, the joined dataset.

2. The method of claim 1, further comprising:
performing, by the module and prior to the receiving of the first dataset, authentication with the 1P data source.

3. The method of claim 2, wherein the performing of the authentication includes performing a decryption operation using credentials associated with the 1P data source.

4. The method of claim 1, wherein:
the module implements a secure connector configured to use credentials associated with the 1P data source; and
the matching is implemented in a secure join module which is prevented from accessing the credentials associated with the 1P data source.

5. The method of claim 4, the method further comprising:
providing the first formatted PII data from the secure connector to the secure join module via an extract-transform-load (ETL) pipeline.

6. The method of claim 5, wherein the ETL pipeline is configured to provide the first formatted PII data to (i) the data service and (ii) a repository for time-deferred consumption of the first formatted PII data.

7. The method of claim 4, further comprising:
receiving, at the secure connector, the encrypted DEK associated with the 1P data source;
providing, from the secure connector to the secured join module, the encrypted DEK.

8. The method of claim 7, further comprising:
decrypting the encrypted DEK using a key management service (KMS) to generate a DEK;
wherein:
the PII data received with the first dataset from the 1P data source is encrypted;
the pre-processing of the PII data includes decrypting the received PII data prior to generating the first formatted PII data.

9. The method of claim 8, further comprising:
encrypting the first formatted PII data using the DEK at the secure connector prior to providing the first formatted PII data to the secure join module.

10. The method of claim 8, further comprising:
hashing the first formatted PII data at the secure connector prior to providing the first formatted PII data to the secure join module.

11. The method of claim 10, wherein the matching of the first formatted PII data to second formatted PII data is implemented in the secure join module and is based on hashed PII data.

12. The method of claim 11, further comprising:
discarding non-matched rows in the first dataset and the second dataset.

13. The method of claim 1, wherein:
both the receiving and the matching are implemented in the module configured to operate as a secure connector and a PII match component; and
the providing of the joined dataset includes providing the joined dataset from the secure connector and the PII match component to the data service via an ETL pipeline.

14. The method of claim 1, wherein the receiving of the first dataset includes receiving the first dataset in cleartext over an encrypted link.

15. A system comprising:
one or more servers including processing hardware and configured to:
receive, at a module executing in a trusted execution environment (TEE) from a first-party (1P) data source, a first dataset including personal identifiable information (PII) data and non-PII data;
pre-process the PII data to generate first formatted PII data, the first formatted PII data conforming to a predefined format;
match, in the TEE, the first formatted PII data to second formatted PII data included in a second dataset;
perform a join operation between the first dataset and the second dataset based on the matching, to generate a joined dataset; and
provide, to a data service operating independently of the 1P data source, the joined dataset.

16. The system of claim 15, wherein the one or more servers are further configured to:
perform, by the module and prior to the receiving of the first dataset, authentication with the 1P data source.

17. The system of claim 16, wherein the one or more servers are configured to perform the authentication by performing a decryption operation using credentials associated with the 1P data source.

18. The system of claim 15, wherein:
the module implements a secure connector configured to use credentials associated with the 1P data source; and
the matching is implemented in a secure join module which is prevented from accessing the credentials associated with the 1P data source.

19. The system of claim 18, wherein the one or more servers are further configured to:
provide the first formatted PII data from the secure connector to the secure join module via an extract-transform-load (ETL) pipeline.

20. The system of claim 19, wherein the ETL pipeline is configured to provide the first formatted PII data to (i) the data service and (ii) a repository for time-deferred consumption of the first formatted PII data.
